(19) United States
(12) Patent Application Publication
(10) Pub. No.: US 2002/0141656 A1
(43) Pub. Date: Oct. 3, 2002

(54) Image file generating program product, an image processing program product, an image file generating apparatus, and an image file generating method

(75) Inventors: Masahito Niikawa, Sakai-Shi (JP); Ryoji Bando, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/112,351

(22) Filed: Mar. 29, 2002

(30) Foreign Application Priority Data
Mar. 30, 2001 (JP) 2001-102278

(51) Int. Cl. G06K 9/36

(52) U.S. Cl. 382/276

(57) ABSTRACT

A computer is caused to perform a step of receiving a processing purpose corresponding to an image data stored in a first storage area and inputted by a user, a step of storing the received processing purpose in a second storage area, a step of receiving a content of processing to the image data inputted by the user in conformity with the processing purpose of the image data, and a step of storing the received content of processing in a third storage area. An aimed image processing result can be easily obtained within a short period of time.

This application is based on patent application No. 2001-102278 filed in Japan, the contents of which are hereby incorporated by references.

### BACKGROUND OF THE INVENTION

This invention relates to an image file generating apparatus and method for generating an image file, image file generating program product, and image processing program product.

Conventionally, an image processing has been applied to an image data stored in an image file to change color tone, brightness, contrast, etc. using an image processing apparatus such as a personal computer. In such a case, an image data is degraded every time the image processing is repeated and it becomes difficult to restore the image data to the original one. Thus, it has been necessary to pay a careful attention to administration of the image data such as backup storage of the original image data. In view thereof, it has been proposed to separately administer the original image data and the image data obtained by applying a specified image processing to the original image data (see Japanese Unexamined Patent Publication Nos. 63-82553, 7-85237, 2000-57334 and 2000-76474.

Although the above proposed technique considers saving of the original image data, it is difficult for users unaccustomed to the image data processing to operate and has not necessarily always led to an aimed image processing result within a short period of time.

### SUMMARY OF THE INVENTION

It is an object of the present invention to provide novel image file generating technique and image processing technique which are free from the problems residing in the prior art.

According to an aspect of the present invention, an image file is generated which has a first storage area for storing an image data, a second storage area for storing a processing purpose of the image data, and a third storage area for storing a content of processing to the image data, or alternatively a fourth storage area for storing an order data of an article using the image data in addition to the first, second, and third storage areas.

There are image file generating program products or apparatus. The program product includes a program and a signal bearing medium for bearing the program.

An image file generating program causes a computer to perform a step of receiving a processing purpose corresponding to the image data stored in the first storage area and inputted by a user, a step of storing the received processing purpose in the second storage area, a step of receiving a content of processing to the image data inputted by the user in conformity with the processing purpose of the image data, and a step of storing the received content of processing in the third storage area.

Another image file generating program causes a computer to perform a step of receiving a processing purpose newly inputted by a user, a step of overwriting the processing purpose stored in the second storage area with the newly received processing purpose, a step of receiving a content of processing newly inputted by the user in conformity with the new processing purpose, and a step of overwriting the content of processing stored in the third storage area with the newly received content of processing.

Still another image file generating program causes a computer to perform a step of receiving a processing purpose corresponding to the image data stored in the first storage area and inputted from an external apparatus via a communication network when an article to be ordered is designated to the external apparatus via the communication network, a step of storing the received processing purpose in the second storage area, a step of receiving a content of processing to the image data inputted by the user in conformity with the processing purpose of the image data, a step of storing the received content of processing in the third storage area, a step of receiving an order data used to order an article using the image data and inputted by the user, and a step of storing the received order data in the fourth storage area.

An image file generating apparatus includes an input part which inputs the processing purpose of the image data stored in the first storage area and the content of processing to the image data corresponding to the processing purpose; and a storage controller which allows storing of the processing purpose inputted by the input part in the second storage area, and the content of processing inputted by the input part in the third storage area.

Another image file generating apparatus includes an input part which inputs the content of processing to the image data stored in the first storage area corresponding to the processing purpose of the image data and the order data used to order the article using the image data, and a storage controller which allows storing of the processing purpose inputted from an external apparatus via a communication network in the second storage area when the article to be ordered is designated to the external apparatus via the communication network, and storing of the content of processing inputted by the input part in the third storage area, and storing of the order data inputted by the input means in the fourth storage area.

According to still another aspect of the present invention, a program product is adapted for applying an image processing to an image data using an image file in which the image data is stored in a first storage area, a processing purpose of the image data is stored in a second storage area, and a content of processing to the image data in conformity with the processing purpose is stored in a third storage area. The program product includes a program causing a computer to perform a step of reading the image data from the first storage area, a step of storing the read image data in a processing storage medium, a step of reading the processing purpose from the second storage area, a step of reading the content of processing from the third storage area, and a step of applying an image processing to the image data stored in the processing storage medium based on the read content of processing in conformity with the processing purpose, and a signal bearing medium which bears the program.

According to further another aspect of the present invention, a method for processing an image file, comprises receiving a processing purpose for an image data, receiving a processing content corresponding to the processing purpose, and generating an image file including a first storage area for storing the image data, a second storage area for storing the processing purpose, and a third storage area for storing the processing content.

These and other objects, features and advantages of the present invention will become more apparent upon a reading of the following detailed description and accompanying drawings.

### BRIEF DESCRIPTION OF THE DRAWINGS

FIG. 1 is a diagram showing an external construction of an image file generating apparatus according to an embodiment of the invention;

FIG. 2 is a block diagram showing a control construction of the image file generating apparatus of FIG. 1;

FIG. 3 is a flowchart summarily showing a series of operations of the image file generating apparatus of FIG. 1;

FIG. 4 is a diagram showing a file format of an image file generated by the image file generating apparatus of FIG. 1;

FIG. 5 is a diagram showing an operation screen displayed on a display device of the image file generating apparatus of FIG. 1;

FIG. 6 is a diagram showing another operation screen displayed on a display device of the image file generating apparatus of FIG. 1;

FIG. 7 is a diagram showing still another operation screen displayed on a display device of the image file generating apparatus of FIG. 1;

FIG. 8 is a diagram showing further another operation screen displayed on a display device of the image file generating apparatus of FIG. 1;

FIG. 9 is a diagram showing still further another operation screen displayed on a display device of the image file generating apparatus of FIG. 1;

FIG. 10 is a flowchart showing a series of operations performed to apply an image processing to an image data;

FIG. 11 is a flowchart showing another series of operations performed to apply an image processing to the image data;

FIG. 12 is a flowchart showing still another series of operations performed to apply an image processing to the image data;

FIG. 13 is a flowchart showing further another series of operations performed to apply an image processing to the image data;

FIG. 14 is a flowchart showing still further another series of operations performed to apply an image processing to the image data;

FIG. 15 is a diagram showing a file format of another image file generated by the image file generating apparatus of FIG. 1;

FIG. 16 is a flowchart showing a series of operations performed in the case of generating the image file of FIG. 15;

FIG. 17 is a diagram showing a state where the image file generating apparatus of FIG. 1 is connected with an external apparatus via Internet;

FIG. 18 is a diagram showing an operation screen displayed on the display device of the image file generating apparatus of FIG. 1;

FIG. 19 is a diagram showing an order image displayed on the display device of the image file generating apparatus in the case articles are ordered via Internet; and

FIG. 20 is a flowchart showing a series of operations in the external apparatus having received an order.

### DETAILED DESCRIPTION OF THE PREFERRED EMBODIMENTS OF THE PRESENT INVENTION

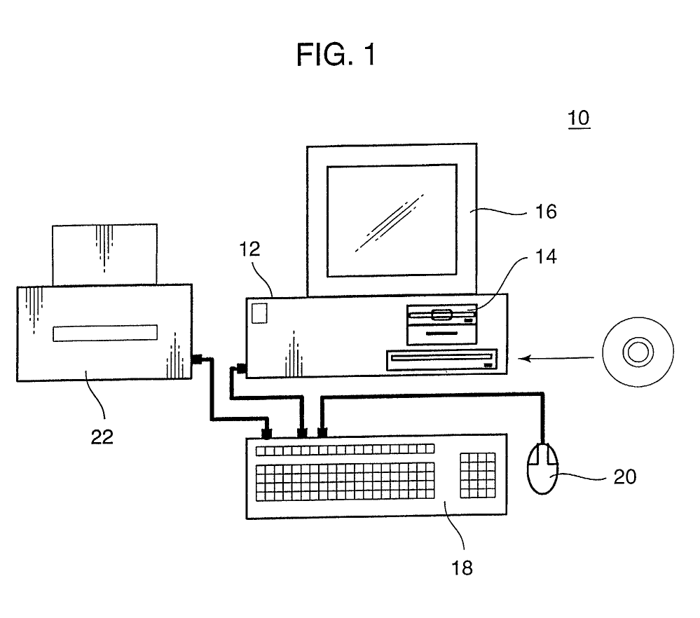

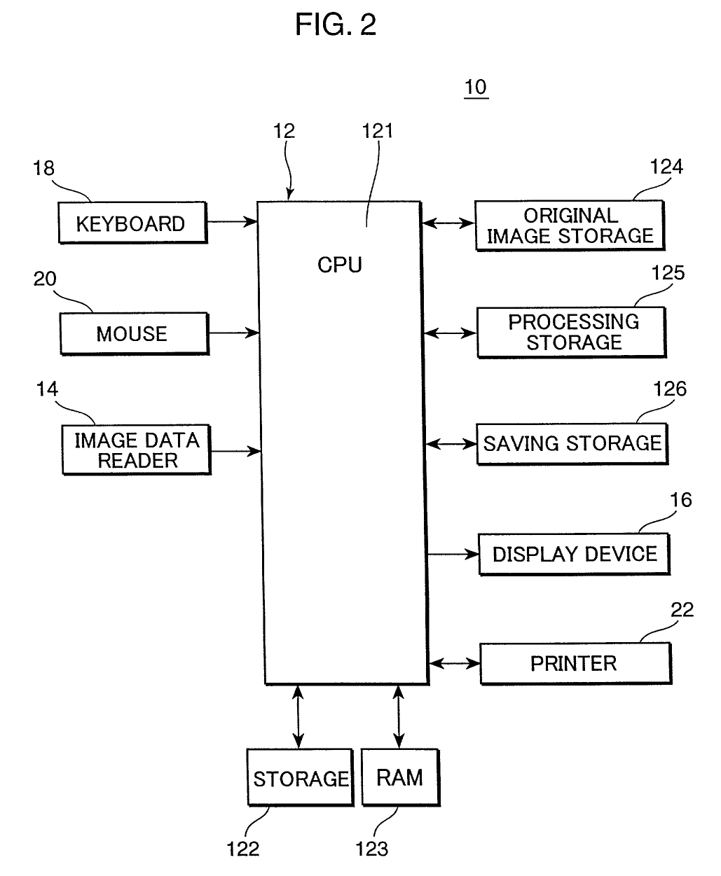

Referring to FIGS. 1 and 2, an image file generating apparatus 10 is constructed, for example, by a personal computer and is comprised of a main controller 12, an image data reader 14 connected with the main controller 12, a display device 16 formed of a CRT (Cathode-Ray Tube) display or the like connected with the main controller 12, a keyboard 18 as a first input device connected with the main controller 12, a mouse 20 as a second input device connected with the main controller 12, and a printer 22 connected with the main controller 12.

The main controller 12 is provided with a CPU 121 for executing operations, a storage 122 such as a hard disk for storing a processing program and various data, and a RAM 123 for temporarily saving the data. With the main controller 12 are connected an original image storage 124 for storing or saving an image data read by the image data reader 14 and storing a purpose of processing or purpose of using this image data and contents of processing and the like for the image data, a processing storage 125 used to temporarily save the image data read from the original image storage 124 and apply an image processing to the saved image data, and a saving storage 126 for saving the image data having the image processing applied thereto. These storages 124, 125 and 126 are formed, for example, of hard disk.

The image data reader 14 is constructed such that a memory storing image data obtained by picking up images using an image pickup device such as an electronic camera and pieces of image information belonging to the image data is mountable, and is adapted to read the image data and the like stored in the mounted memory. The image data and the like read by the image data reader 14 are stored in the original image storage 124. Alternatively, image data and the like stored in a memory built in an image pickup device may be directly read by connecting the image pickup device of an electronic camera or the like with the main controller 12 via a USB cable. Further alternatively, a subject image recorded on a photosensitive sheet or the like may be read by means of a scanner, and the read image data may be stored in the original image storage 124.

The display device 16 displays an image on a display surface 161 based on the image data read from the original image storage 124 or the processing storage 125 and permits application of specified processings while the image is displayed on the display surface 161. The keyboard 18 and the mouse 20 are used to input the purpose of processing the image data, the contents of processing and the like for the image data and various other pieces of image information stored in the original image storage 124. The various pieces of image information including the processing purpose and the contents of processing inputted by means of the keyboard 18 and the mouse 20 are stored together with the image data in the original image storage 124 after being temporarily received by the RAM 123. The printer 22 is adapted to print out the image stored in the original image storage 124 and the image having the image processing applied thereto on a recording sheet.

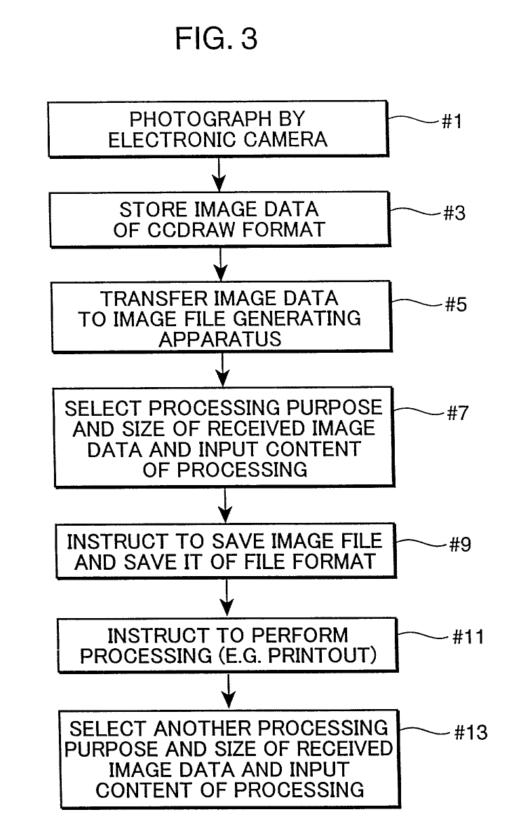

FIG. 3 is a flowchart summarily showing a series of operations of generating an image file using the image file generating apparatus 10 thus constructed and executing the processing purpose based on the generated image file. The operations also including a step of photographing a subject by means of an image pickup device such as an electronic camera are described.

First, when a subject is photographed by means of the image pickup device such as an electronic camera (Step #1), the photographed image is stored in a memory provided in the image pickup device as an image of, e.g., CCDRAW format (Step #3). Simultaneously with the image data, pieces of related image information such as the image data format and a gradation number are written in this memory.

Subsequently, the image data stored in the memory of the image pickup device is inputted into the image file generating apparatus 10 by mounting the memory in the image data reader 14 and giving an instruction to start reading, and is stored in the original image storage 124 (Step #5). Here, the original image data stored in the memory of the image pickup device is so stored in the original image storage 124 as to be minimally degraded or not to reduce the resolution.

The processing purpose, e.g., printout, of the inputted image data is selected, the size of the image data or image size which is a content of processing is selected, and other contents of processing, e.g., trimming range, are inputted by operating the keyboard 18 or the mouse 20 (Step #7).

In this embodiment, “Web Site Image Generation”, “Wallpaper Generation” and “Icon Generation” are also selectable as the processing purpose of the image data in addition to the above “Printout”. Further, “Color tone”, “Brightness”, “Contrast”, etc. can be inputted as the content of the processing for the image data in addition to the above “Image Size” and “Trimming Range”. Selection of the processing purpose and the size, etc. are described later.

Subsequently, when an instruction is given to save the file by operating the keyboard 18 or the mouse 20, the image data, the processing purpose, the content of processing, etc. are stored in specified storage areas of the original image storage 124, respectively, and an image file of file format to be described later is generated (Step #9).

Subsequently, when an instruction is given to carry out the processing, e.g., printout, by operating the keyboard 18 or the mouse 20, the image data stored in the image file formed in the original image storage 124 is transferred to the processing storage 125; an image processing is applied to this transferred image data in accordance with the processing purpose and the content of processing which are stored in the image file; and the image data having the image processing applied thereto is sent to the printer 22, which in turn prints the image data on a recording sheet (Step #11).

Thereafter, when an instruction is given to generate another image file having a processing purpose, a content of processing and the like different from those of the previously generated image file while leaving the image data stored in the previously generated image file as it is by operating the keyboard 18 or the mouse 20 if necessary, another processing purpose, e.g., icon generation, and the image size are made selectable. Thus, the processing purpose, the content of processing, etc. are overwritten by the operation similar to that in Step #7, and another new image file is formed by instructing saving of the file (Step #13).

As described above, since the image processing is applied to the image data read from the original image storage 124 and leaving the image data stored in the original image data storage 124 as it is in this embodiment, it is not necessary to back up the original image data and, therefore, the image data can be more easily administered. Further, since the original image data is so stored in the original image storage 124 as to be minimally degraded or not to reduce the resolution, another new image file can be easily generated only by overwriting the processing purpose, the content of processing and the like of the generated image file. Instead of image data of CCDRAW format, RGB image data after pixel interpolation may be stored.

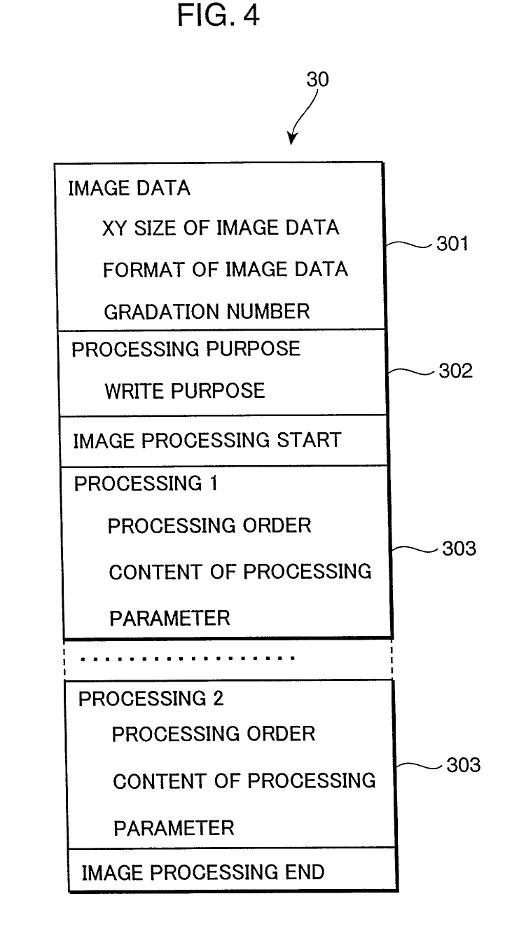

FIG. 4 is a diagram showing the file format of the above image file generated by the image file generating apparatus 10. Specifically, an image file 30 generated by the image file generating apparatus 10 is provided with a first storage area 301 for storing the image data inputted by, for example, being read by means of the image data reader 14, a second storage area 302 for storing the processing purpose of the image data stored in the first storage area 301, and a third storage area 303 for storing the content of processing applied to the image data stored in the first storage area 301.

The size of the image data which is defined in horizontal direction X and vertical direction Y, the format of the image data, e.g., CCDRAW format, the gradation number and the like are simultaneously stored in the first storage area 301. The “Printout”, “Web Site Image Generation”, “Wallpaper Generation” or the like is stored as the processing purpose in the second storage area 302. A plurality of processing recording columns are set in the third storage area 303, and the order of processings, contents of processing, parameters, etc. are recorded in the respective processing recording columns. An image processing start command is written between the second storage area 302 storing the processing purpose and the third storage area 303 storing the content of processing, and an image processing end command is written after the third storage area 303. The data are written in these storage areas 301 to 303 in Step #9 shown in FIG. 3.

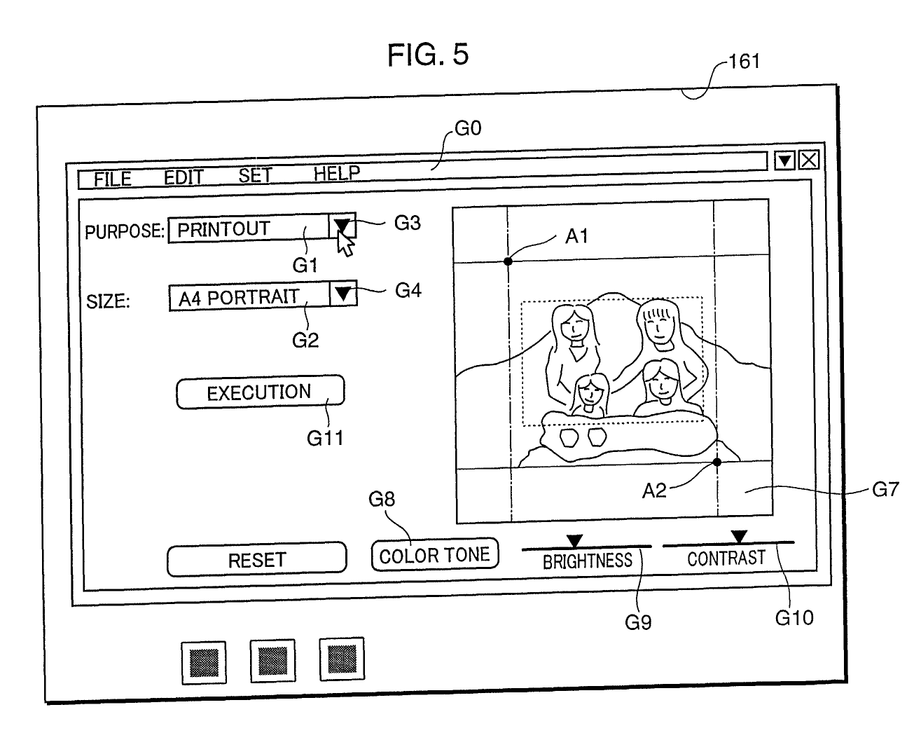

FIG. 5 is a diagram of an operation screen displayed on the display device 16 used to explain the operation in Step #7. In other words, the operation screen of FIG. 5 is displayed on the display surface 161 of the display device 16 by operating the keyboard 18 or the mouse 20.

A tool bar GO is set at the top of this operation screen, wherein respective items of “File”, “Edit”, “Set” and “Help” are displayed. When “File” is designated by means of the keyboard 18 or the mouse 20, a list of operation contents of “Listen”, “Close”, “Save”, “Save Under”, “Print”, “End” and “Connect with Photo Service” is displayed on the screen.

The image file 30 can be opened by designating “Open”, whereas the opened image file can be closed by designating “Close”. Upon designating “Save” and “Save Under” are designated, the content selected or designated can be saved in the corresponding storage area of the image file 30. When “Print” is designated, printing can be carried out by the printer 22 only when “Printout” is selected as the processing purpose. The application can be ended by designating “End”. By designating “Connect with Photo Service”, a photo service or the like can be ordered to an external shop concerned via a communication network such as Internet.

When “Edit” is designated by means of the keyboard 18 or the mouse 20, the processing purpose and the content of processing can be selected or designated. When “Set” is designated, the type of the printer 22, a compression rate and the like can be set. When “Help” is designated, various operation guides are displayed.

For example, the operation screen shown in FIG. 5 can be displayed by designating “File” to display a list, and then designating “Open” and “Edit”. A purpose display box or list box G1 is set at the upper left part of this operation screen, and the selected processing purpose is displayed in this purpose display box G1. In other words, a plurality of processing purposes set beforehand can be selectively displayed in this purpose display box G1 by repeatedly clicking a designation button G3 provided at the right side of the box G1 by means of the mouse 20. In this embodiment, “Printout”, “Web Site Image Generation”, “Wallpaper Generation” and “Icon Generation” are set beforehand as the processing purposes as described above. In this operation screen, “Printout” is set.

A size display box or list box G2 is set below the purpose display box G1, and the size of the selected image is displayed in this size display box G2. A plurality of sizes set beforehand can be selectively displayed in this size display box G2 by repeatedly clicking a designation button G4 provided at the right side of the box G2 by means of the mouse 20. Choices of the sizes differ depending on the selected processing purpose.

Specifically, when “Printout” is designated, “A4 portrait”, “A4 landscape”, “A5 portrait”, “A5 landscape”, “Card Size portrait” and “Card Size landscape” are selectable in this embodiment. When “Web Site Image Generation” is designated, “1024×768 pixels”, “800×600 pixels”, “768×512 pixels”, “640×480 pixels”, “320×240 pixels” and “160×768 pixels” are selectable in this embodiment.

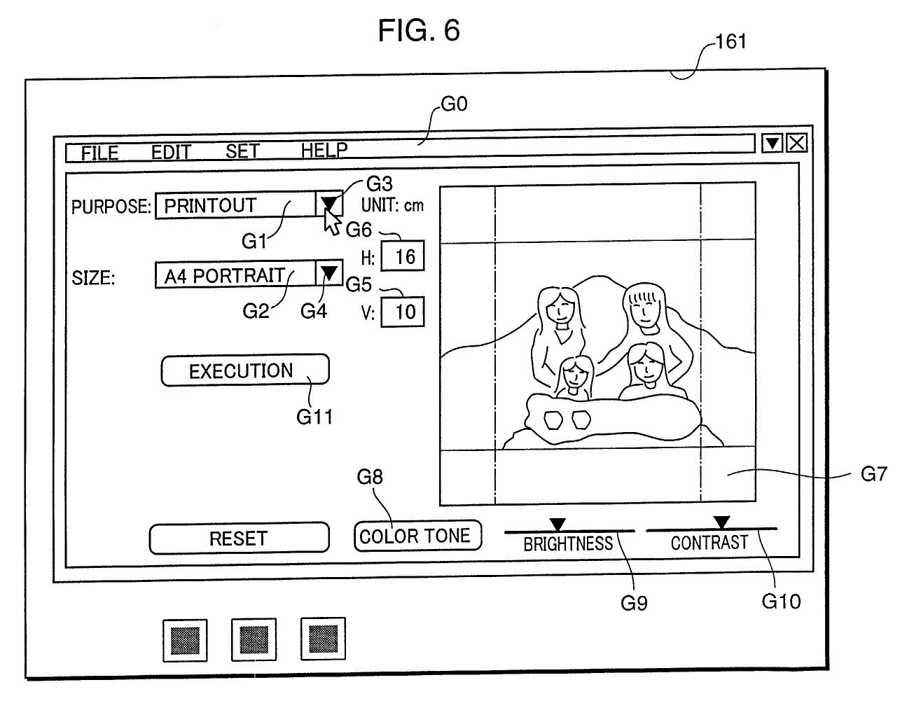

When “Wallpaper Generation” is selected, “1600×1200 pixels”, “1200×1024 pixels”, “1024×768 pixels”, “800×600 pixels” and “640×480 pixels” are selectable in this embodiment. When “Icon Generation” is selected, only “64×64 pixels” can be designated. “Arbitrary” can be selected in the size display box G2. When “Arbitrary” is selected, a vertical size box G5 and a horizontal size box G6 are displayed at the right side of the size display box G2 as shown in FIG. 6, and desired values (cm) can be inputted within ranges set beforehand by means of the keyboard 18 to be displayed in the respective boxes G5, G6.

An image display section G7 is set at the right side of the operation screen, and the image data stored in the image file 30 is read and displayed in the image display section G7 and a trimming range of the image displayed is set by operating the mouse 20. In this embodiment, the trimming range is the one enclosed by solid lines and broken lines and is expressed by coordinate values of two diagonally located points A1, A2.

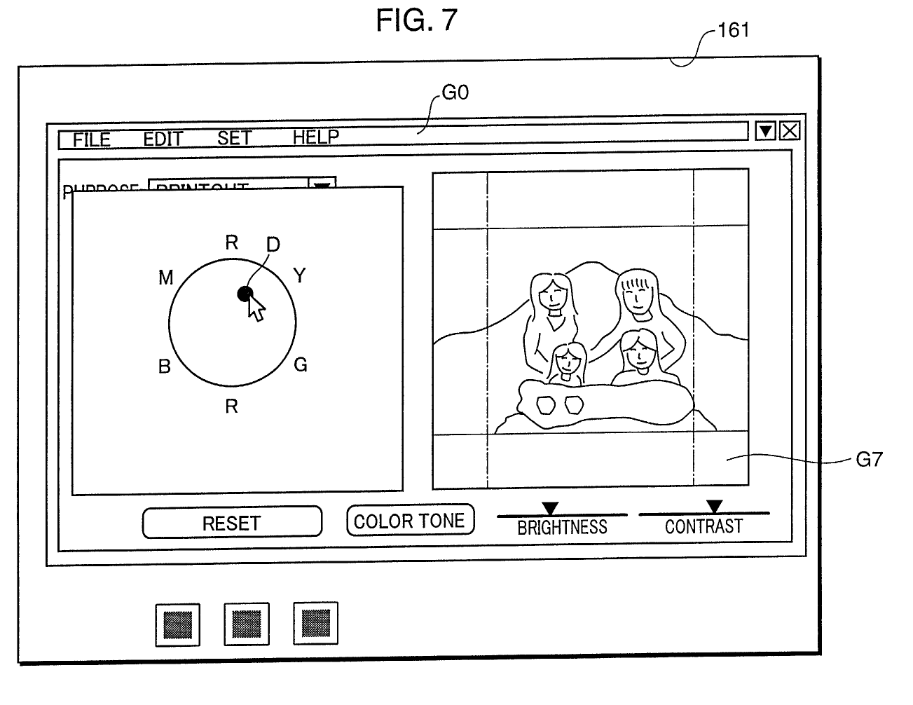

A tone button G8 is set at the bottom of the center part, and the color tone of the image can be set by clicking this tone button G8 by means of the mouse 20. Specifically, when the tone button G8 is clicked, a tone designation screen is displayed in the middle of the left part of the operation screen in this embodiment as shown in FIG. 7 and color tone can be adjusted by moving a dot D within a circle displayed in the center of this designation screen to a specified position within the circle by operating the mouse 20. The color tone of the image displayed in the image display section G7 at the right side can be changed by moving the dot D, so that a user can adjust the color tone to a favorite one while looking at this image.

A brightness scale G9 and a contrast scale G10 are set at the bottom of the right side of the operation screen (below the image display section G7). In this brightness scale G9, brightness can be set to darken the image by moving an index shown by a black triangle to left by means of the mouse 20 while being set to brighten the image by moving the index to right by means of the mouse 20 when the color tone of the image is settable. In the contrast scale G10, contrast of the image can be weakened by moving an index shown by a black triangle to left by means of the mouse 20 while being strengthened by moving the index to right by means of the mouse 20 when the color tone of the image is settable.

Further, rotation and inversion such as “90° Rotation to Right”, “90° Rotation to Left”, “180° Rotation”, “Horizontal Inversion” and “Vertical Inversion” can be applied to the image within the trimming range displayed in the image display section G7 by operating the keyboard 18 or the mouse 20.

An execution button G11 is set in the center of the right side of the operation screen. Selection of the processing purpose (“Printout” in this example) can be confirmed by clicking this execution button G11 by means of the mouse 20 and the confirmed processing purpose is stored in the second storage area 302 of the image file 30. Various selections or designations of the size, trimming range, color tone, brightness, contrast and image rotation/inversion which are contents of processing can be confirmed by clicking the execution button G11, and these contents of processing are stored in the third storage area 303 of the image file 30.

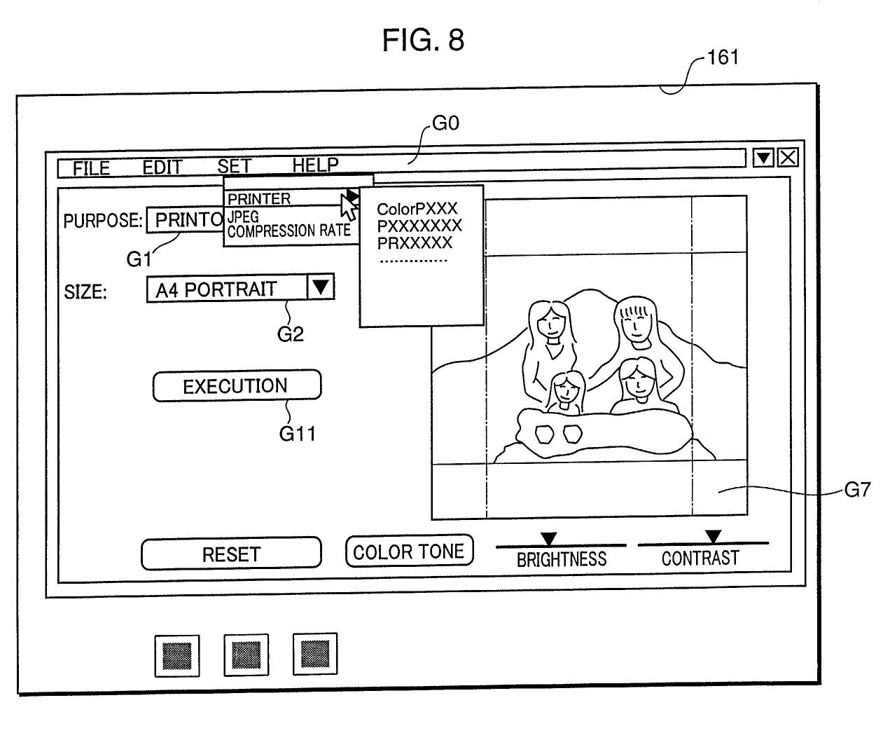

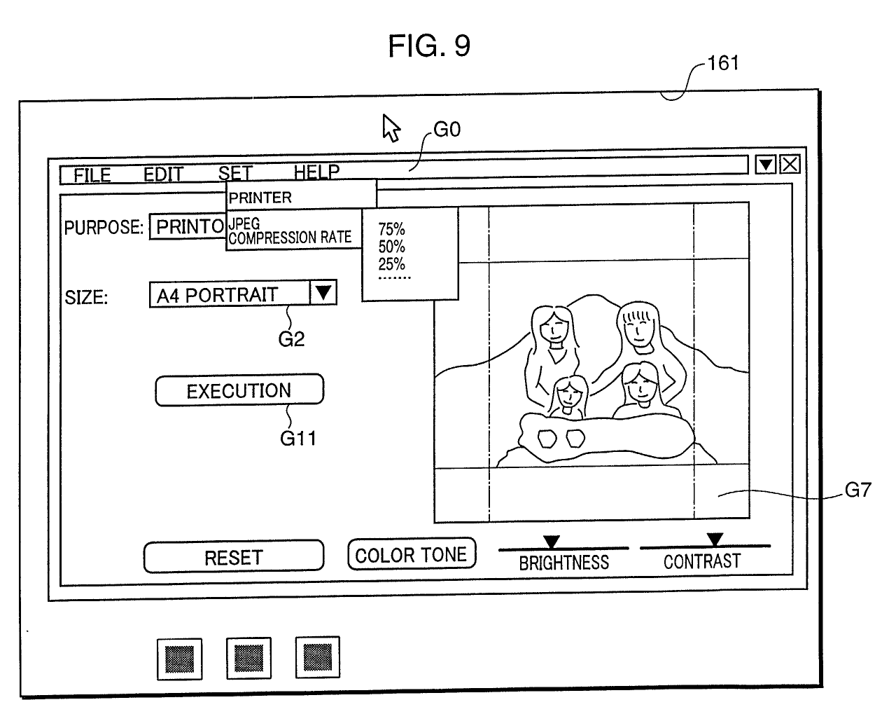

When “Set” in the tool bar G0 is designated with the operation screen opened, a list of “Printer”, “Compression Rate”, etc. is displayed as shown in FIGS. 8 and 9. When “Printer” in this list is designated, the types of printers 22 connected with the main controller 12 are displayed as shown in FIG. 8. Thus, one printer 22 can be designated when a plurality of types of printers 22 are connected. When “Compression Rate” in this list is designated, a list of a plurality of compression rates is displayed as shown in FIG. 9 and one compression rate can be selected from this list. The type of the printer 22 and the compression rate are also stored as one of the contents of processing in the third storage area 303 of the image file 30. In this way, the specified data are stored in the respective storage areas 301, 302, 303 and the image file 30 aimed at by the user can be completed.

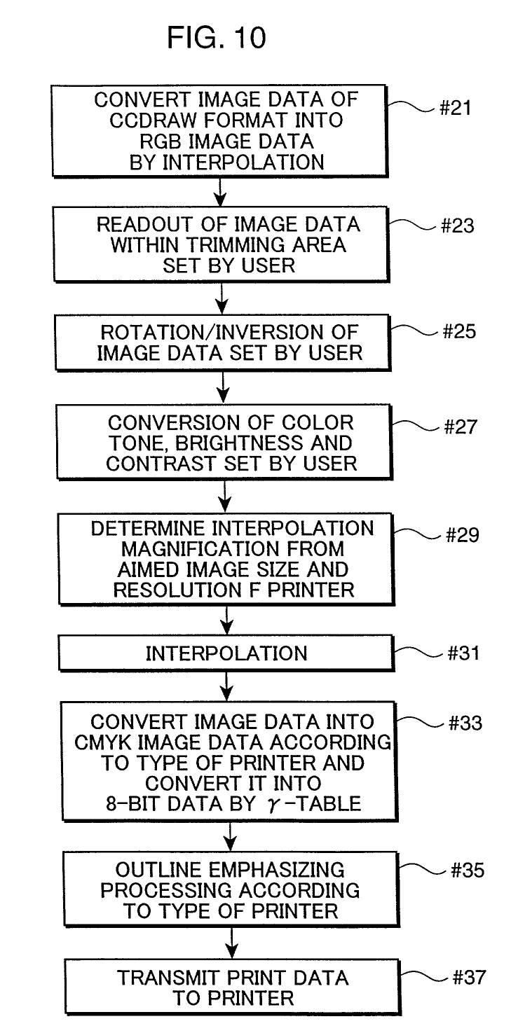

FIG. 10 is a flowchart showing operations of applying an image processing to the image using the image file 30 thus generated when the processing purpose stored in the second storage area 302 is “Printout”. Specifically, since the processing purpose “Printout” is stored in the second storage area 302 of the image file 30 according to the present invention, the application purpose of the image file 30 can be made clear. As a result, such a confusion as to mistakenly use the image file 30 for a purpose other than “Printout” can be avoided. Hereinafter, the processing operations are summarily described with reference to this flowchart.

First, when the keyboard 18 is operated to instruct the execution of the image processing to the image data stored in the image file 30, the image data of CCDRAW format stored in the first storage area 301 is transferred to the processing storage 125 and an interpolation is carried out to convert the transferred image data of CCDRAW format into an RGB image data (Step #21). After the interpolation is carried out, the image data within the trimming range stored in the third storage area 303 is read (Step #23). An image is displayed on the display surface 161 of the display device 16 based on the read image data.

Subsequently, rotation/inversion is applied to the image data stored in the processing storage 125 based on the image data rotation or inversion data stored in the third storage area 303 (Step #25). After this rotation/inversion is applied, the resulting image is displayed on the display surface 161.

Subsequently, the color tone, brightness and contrast of the image data stored in the processing storage 125 are changed based on the color tone data, brightness data and contrast data stored in the third storage area 303 (Step #27). After this processing, the resulting image is displayed on the display surface 161.

Subsequently, an interpolation magnification is calculated and determined based on the size data and the resolution of the printer 22 stored in the third storage area 303 (Step #29) and an interpolation is applied to the image data stored in the processing storage 125 (Step #31). The resulting image data is converted into a CMYK image data according to the type of the printer 22 and then converted into an 8-bit data by a γ-table (Step #33). Thereafter, an outline emphasizing processing in conformity with the type of the printer 22 is applied (Step #35) and a print data is transmitted to the printer 22 (Step #37). Then, the printer 22 performs printing based on the received print data.

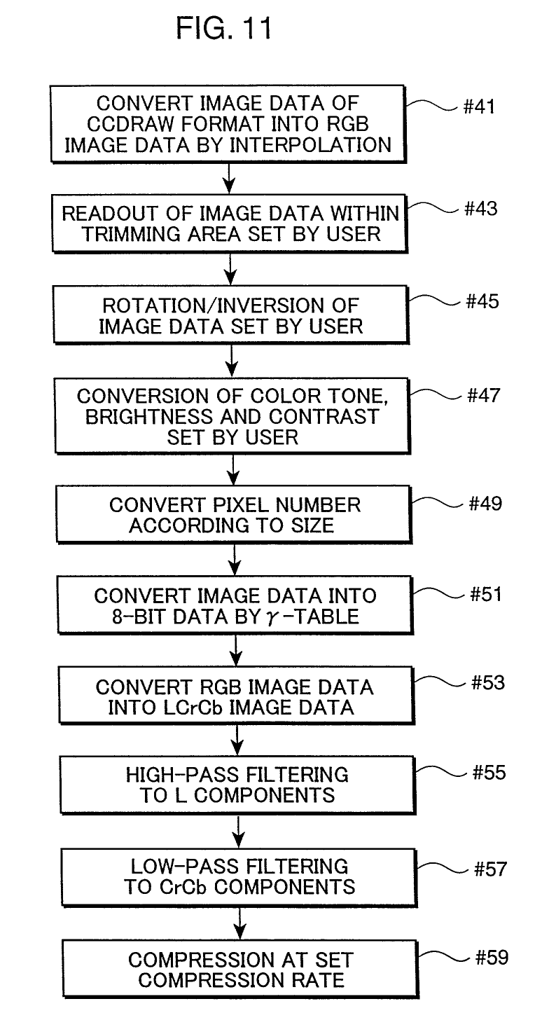

FIG. 11 is a flowchart showing operations of application an image processing to the image using the image file 30 generated as above when the processing purpose stored in the second storage area 302 is “Web Site Image Generation”. Specifically, since the processing purpose “Web Site Image Generation” is stored in the second storage area 302 of the image file 30, the application purpose of the image file 30 can be made clear. As a result, such a confusion as to mistakenly use the image file 30 for a purpose other than “Web Site Image Generation” can be avoided. Hereinafter, the processing operations are summarily described with reference to this flowchart.

First, when the keyboard 18 is operated to instruct the execution of the image processing to the image data stored in the image file 30, the image data of CCDRAW format stored in the first storage area 301 is transferred to the processing storage 125 and an interpolation is carried out to convert the transferred image data of CCDRAW format into an RGB image data (Step #41). This interpolation is carried out, for example, by generating a RGB data of one pixel from RGB data around a target pixel. After the interpolation is carried out, the image data within the trimming range stored in the third storage area 303 is read (Step #43). An image is displayed on the display surface 161 of the display device 16 based on the read image data.

Subsequently, rotation/inversion is applied to the image data stored in the processing storage 125 based on the content of processing of the image data stored in the third storage area 303 (Step #45). After this rotation/inversion is applied, the resulting image is displayed on the display surface 161.

Subsequently, the color tone, brightness and contrast of the image data stored in the processing storage 125 are changed based on the color tone data, brightness data and contrast data stored in the third storage area 303 (Step #47). After this processing, the resulting image is displayed on the display surface 161.

Subsequently, a pixel number is converted in conformity with the size data stored in the third storage area 303 (Step #49) and then the image data is converted into an 8-bit data by the γ-table (Step #51). Thereafter, the RGB image data is converted into an LCrCb image data (Step #53) and low-pass filtering is applied to L components (Step #55). Then, high-pass filter is applied to CrCb components (Step #57), and the resulting image data is compressed based on a compression rate stored in the third storage area 303 (Step #59). An image for web site is formed based on the thus obtained image data.

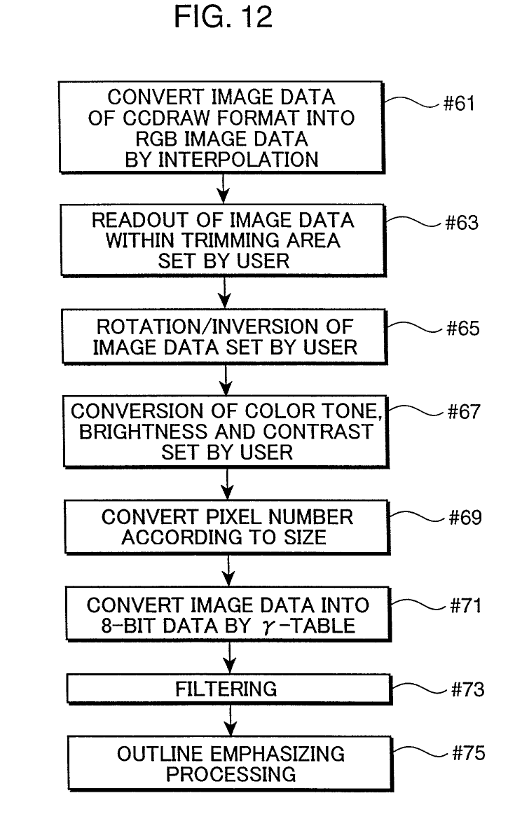

FIG. 12 is a flowchart showing operations of applying an image processing to the image using the image file 30 generated as above when the processing purpose stored in the second storage area 302 is “Wallpaper Generation”. Specifically, since the processing purpose “Wallpaper Generation” is stored in the second storage area 302 of the image file 30, the application purpose of the image file 30 can be made clear. As a result, such a confusion as to mistakenly use the image file 30 for a purpose other than “Wallpaper Generation” can be avoided. Hereinafter, the processing operations are summarily described with reference to this flowchart.

First, when the keyboard 18 is operated to instruct the execution of the image processing to the image data stored in the image file 30, the image data of CCDRAW format stored in the first storage area 301 is transferred to the processing storage 125 and an interpolation is carried out to convert the transferred image data of CCDRAW format into an RGB image data (Step #61). This interpolation is carried out, for example, by averaging RGB data of four pixels to form a RGB data of one pixel when the resolution of the image data of CCDRAW format is high. After the interpolation is carried out, the image data within the trimming range stored in the third storage area 303 is read (Step #63). An image is displayed on the display surface 161 of the display device 16 based on the read image data.

Subsequently, rotation/inversion is applied to the image data stored in the processing storage 125 based on the content of processing of the image data stored in the third storage area 303 (Step #65). After this rotation/inversion is applied, the resulting image is displayed on the display surface 161.

Subsequently, the color tone, brightness and contrast of the image data stored in the processing storage 125 are changed based on the color tone data, brightness data and contrast data stored in the third storage area 303 (Step #67). After this processing, the resulting image is displayed on the display surface 161.

Subsequently, a pixel number is converted in conformity with the size data stored in the third storage area 303 (Step #69) and then the image data is converted into an 8-bit data by the γ-table (Step #71). Thereafter, filtering is carried out (Step #73) and then an outline emphasizing processing is carried out (Step #75). An image for wallpaper is formed based on the thus obtained image data.

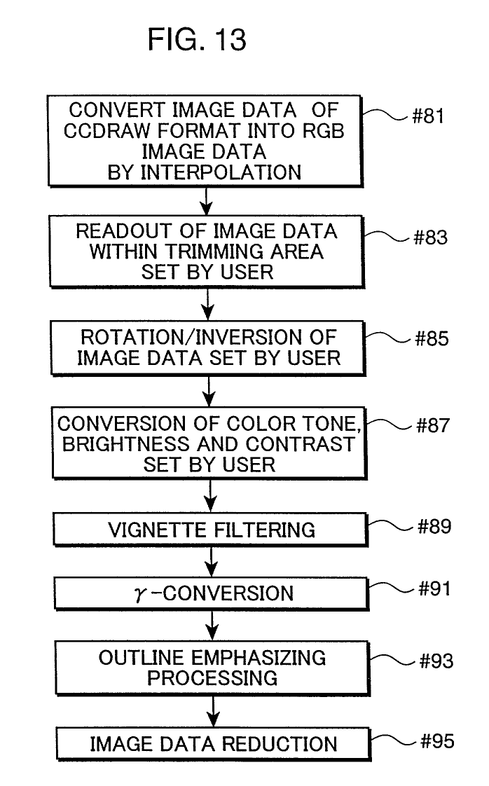

FIG. 13 is a flowchart showing operations of applying an image processing to the image using the image file 30 generated as above when the processing purpose stored in the second storage area 302 is “Icon Generation”. Specifically, since the processing purpose “Icon Generation” is stored in the second storage area 302 of the image file 30 according to the present invention, the application purpose of the image file 30 can be made clear. As a result, such a confusion as to mistakenly use the image file 30 for a purpose other than “Icon Generation” can be avoided. Hereinafter, the processing operations are summarily described with reference to this flowchart.

First, when the keyboard 18 is operated to instruct the execution of the image processing to the image data stored in the image file 30, the image data of CCDRAW format stored in the first storage area 301 is transferred to the processing storage 125 and an interpolation is carried out to convert the transferred image data of CCDRAW format into an RGB image data (Step #81). This interpolation is carried out, for example, by averaging RGB data of 64 pixels to form a RGB data of one pixel. After the interpolation is carried out, the image data within the trimming range stored in the third storage area 303 is read (Step #83). An image is displayed on the display surface 161 of the display device 16 based on the read image data.

Subsequently, rotation/inversion is applied to the image data stored in the processing storage 125 based on the content of processing of the image data stored in the third storage area 303 (Step #85). After this rotation/inversion is applied, the resulting image is displayed on the display surface 161.

Subsequently, the color tone, brightness and contrast of the image data stored in the processing storage 125 are changed based on the color tone data, brightness data and contrast data stored in the third storage area 303 (Step #87). After this processing, the resulting image is displayed on the display surface 161. Thereafter, vignette filtering is applied (Step #89) and γ-conversion is applied (Step #91). Then, the outline emphasizing processing is carried out (Step #93) and an image data reducing processing is carried out (Step #95). An image for icon is formed based on the image data thus obtained.

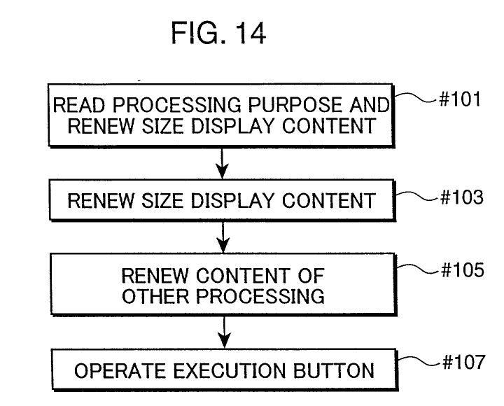

FIG. 14 is a flowchart showing operations of generating another new image file using the image file 30 generated as above by overwriting the processing purpose stored in the second storage area 302 and the content of processing stored in the third storage area 303 while leaving the image data stored in the first storage area 301 as it is. Specifically, in this embodiment, since the original image data obtained by the image pickup device such as an electronic camera is so stored in the image file 30 as to be minimally degraded or not to reduce the resolution, a new image file can be easily generated by overwriting both or either one of the processing purpose and the content of processing of the previously generated image file.

First, the image file 30 stored in the original image storage 124 is read and an operation screen similar to the previous one shown in FIG. 5 is displayed. Specifically, the data is read when the user gives an instruction to read the image file 30, and the processing purpose, e.g., “Printout”, previously set in the purpose display box or list box G1 is displayed. The designation button G3 is clicked by means of the mouse 20 to display another processing purpose, e.g., “Wallpaper Generation” (Step #101).

When the above reading instruction is given, the data are also read and the image size previously set in the size display box or list box G2 is displayed. The designation button G4 is clicked by means of the mouse 20 to display another size corresponding to the processing purpose (Step #103). Thereafter, the respective contents of processing previously set are read and successively renewed so as to correspond to the processing purpose (Step #105). Then, the execution button G11 is clicked by means of the mouse 20 (Step #107). As a result, the processing purpose is overwritten in the second storage area 302 and the processing purpose is overwritten in the third storage area 303, thereby generating a new image file 30. It should be noted that the execution button G11 may be clicked every time the display content of the processing purpose is renewed or the display content of the image size is renewed or every time the contents of processing are renewed, thereby successively overwriting the processing purpose and the contents of processing.

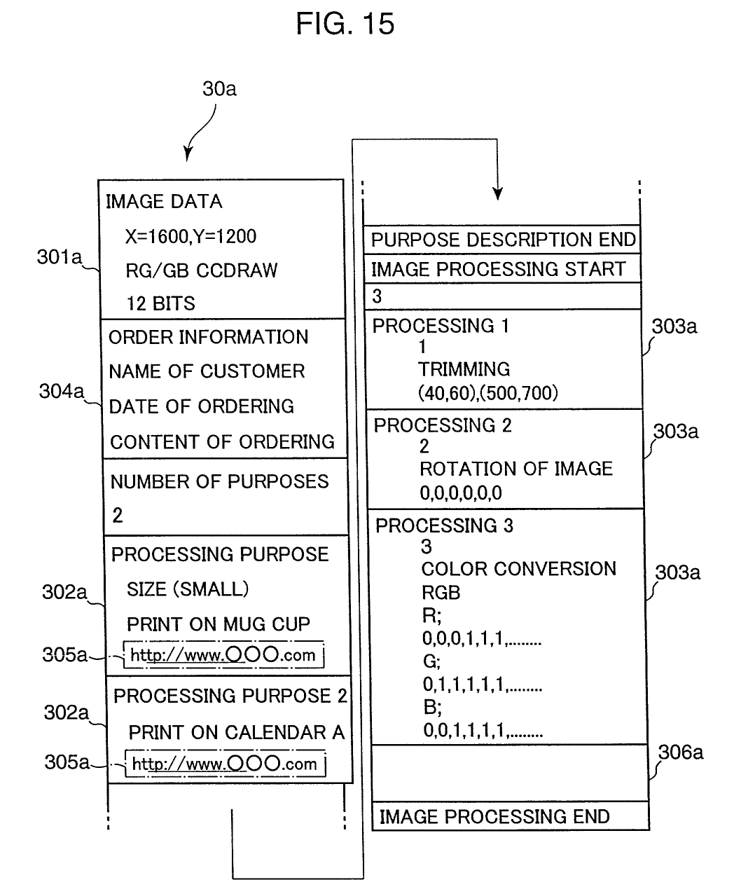

FIG. 15 is a diagram showing a file format of an image file generated by the image file generating apparatus 10 in the case of ordering articles, e.g., mug cups having a transparent seal printed with an image adhered to their circumferential surfaces, calendars printed with images, etc., using an image data via a communication network such as Internet.

Specifically, this image file 30a is comprised of a first storage area 301a for storing an image data inputted, for example, after being read by means of the image data reader 14, a second storage area 302a for storing a processing purpose of the image data stored in the first storage area 301a, a third storage area 303a for storing a content of processing to the image data stored in the first storage area 301a, a fourth storage area 304a for storing an order information or order data used to order articles using the image data stored in the first storage area 301a, a fifth storage area 305a for storing an external apparatus or URL for receiving an order via a communication network, and a sixth storage area 306a for storing the content of processing at the external apparatus.

The same content as the content to be stored in the first storage area 301 of the image file 30 shown in FIG. 3 is stored in the first storage area 301a, for example, after being read by means of the image data reader 14. The purpose and the like of using the image data stored in the first storage area 301a is stored in the second storage area 302a. This second storage area 302a is constructed such that a plurality of processing purposes can be stored. Data inputted from outside via a communication network as described later are stored in the second storage area 302a.

The same content of processing as the one to be stored in the third storage area 303 of the image file 30 shown in FIG. 3 is stored in the third storage area 303a by operating the keyboard 18 or the like. Here, the content of processing stored in this third storage area 303a is common to the plurality of processing purposes stored in the second storage area 302a. The name of a customer, the date of ordering and the content of ordering are stored in the fourth storage area 304a by operating the keyboard 18 or the like. Here, URL is stored in the fifth storage area 305a by operating the keyboard 18 or the like. A processing information including the base color of a mug cup, for example, in the case that an image is printed on a transparent seal to be adhered to the mug cup is inputted at the external apparatus after the ordering, and the content thereof is inputted via the communication network and stored in the sixth storage area 306a.

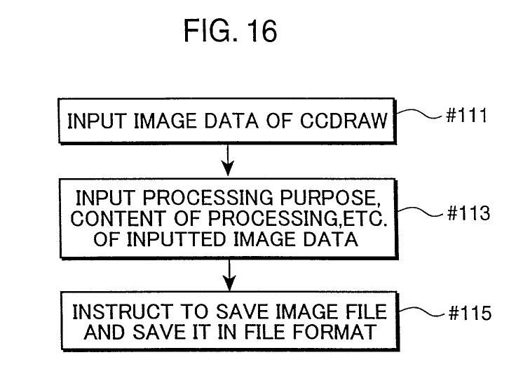

FIG. 16 is a flowchart showing the content of processing when the image file 30a is generated by the image file generating apparatus 10. Specifically, an image data of, e.g., CCDRAW format stored in a memory of an image pickup device such as an electronic camera is inputted to the image file generating apparatus 10 via the image data reader 14 and stored in the original image storage 124 (Step #111). Here, the original image data stored in the memory of the image pickup device is so stored in the original image storage 124 as to be minimally degraded or not to reduce the resolution.

Subsequently, the purpose of processing the image data is inputted from outside via the communication network by ordering articles on the screen, and is stored in the original image storage 124. On the other hand, a specified content of processing, the name of the external apparatus, and the like are inputted and stored in the original image storage 124 by operating the keyboard 18 or the like (Step #113).

When an instruction to save a file is given by operating the keyboard 18 or the mouse 20, the image data, the processing purpose, the content of processing, etc. are respectively saved in specific storage areas of an image file formed in the original image storage 124, thereby generating the image file 30a of file format shown in FIG. 15 (Step #115).

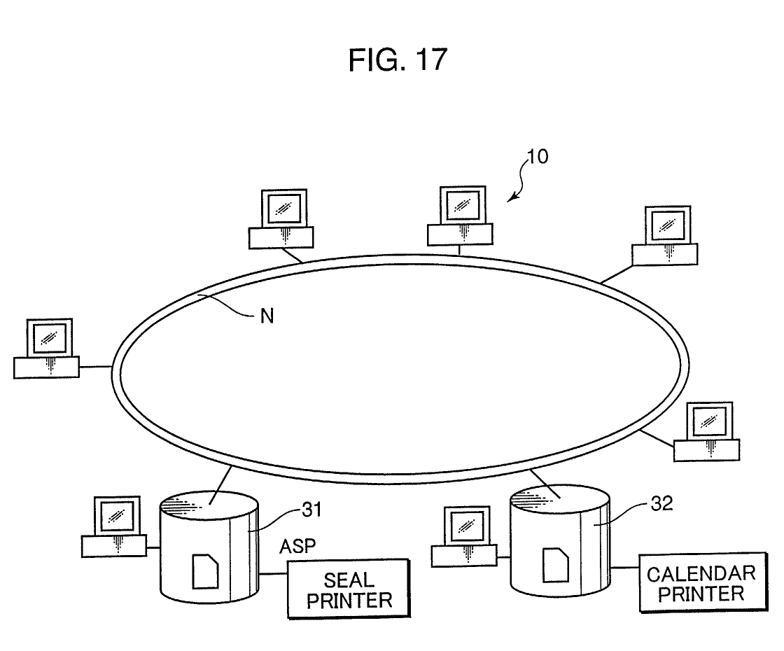

FIG. 17 is a diagram showing a state where the image file generating apparatus 10 is connected with a communication network N such as Internet so as to be connectable with external apparatuses 31, 32 such as servers of an external dealer or application service provider (ASP). Here, the image file generating apparatus 10 is connected via the communication network N with an external apparatus 31 connected with a seal printer for printing a transparent seal to be adhered to a mug cup and an external apparatus 32 connected with a calendar printer for printing a calendar.

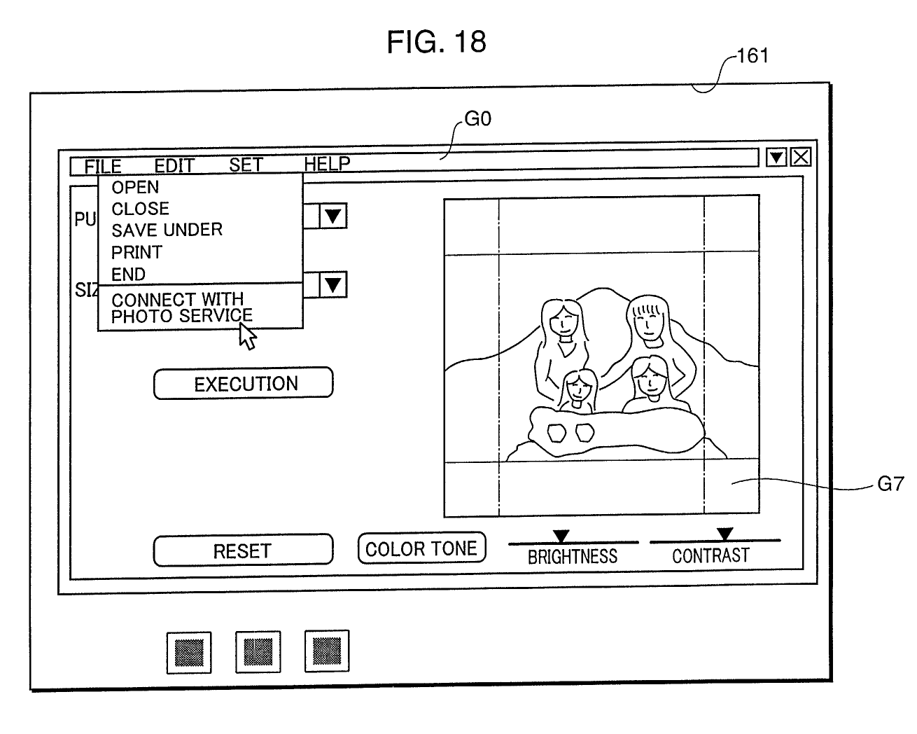

FIG. 18 shows an operation screen displayed on the display surface 161 in the case of ordering articles using the image data stored in the image file 30a via the communication network N such as Internet. Specifically, when “File” in the menu bar G0 shown in FIG. 5 is designated by means of the mouse 20 or the like, a screen of “Connect with Photo Service” is displayed, and the image file generating apparatus 10 is connected with the external apparatuses 31, 32 by designating “Connect with Photo Service” by means of the moue 20 or the like.

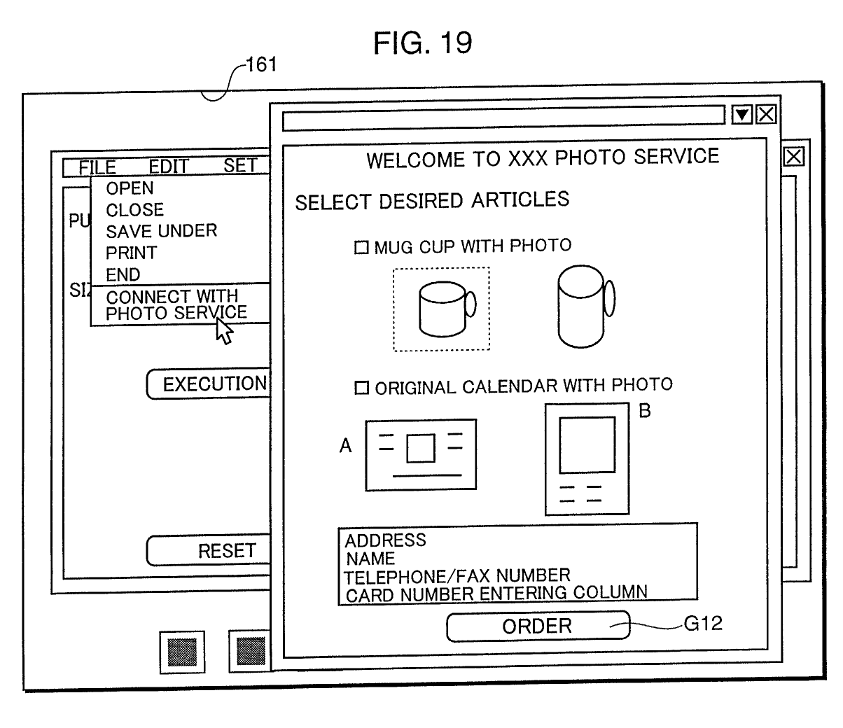

FIG. 19 is a diagram showing an ordering screen displayed on the display surface 161 when the image file generating apparatus 10 is connected with the external apparatuses 31, 32. This ordering screen is inputted from the external apparatuses 31, 32 via the communication network N and is configured such that mug cups with photos and original calendars with photos can be simultaneously ordered. By clicking a checking blank of the mug cups with photos, either one or both of large and small mug cups can be ordered. Here, a case where a small mug cup was ordered is illustrated. Further, by clicking a checking blank of the original calendars with photos, either one or both of horizontal (A) and vertical (B) calendars can be ordered. Here, a case where the horizontal (A) calendar was ordered is illustrated.

On this ordering screen are provided blanks in which the address, name, telephone/fax number of a customer and his card number in the case of payment with a credit card should be entered, which items are inputted by operating the keyboard 18 or the like. Below this ordering screen is provided an order button G12, which is clicked to confirm the content of ordering. Upon being confirmed by clicking the order button G12, the content of ordering is inputted to the image file generating apparatus 10 via the communication network N and stored in the second storage area 302a of the image file 30a shown in FIG. 15. Specifically, “Print on Small-Size Mug Cup” is stored as the processing purpose of the image data in a column of processing purpose 1 shown in FIG. 15, and “Print on Calendar A” is stored in a column of processing purpose 2.

After the processing purposes are stored in the second storage area 302a of the image file 30a, the image file 30a is read from the original image storage 124 and transmitted to the external apparatuses 31, 32 via the communication network N. At the side of the external apparatuses 31, 32, a processing information including the base color of the mug cup in the case that an image is printed on a transparent seal to be adhered to the mug cup is inputted and stored in the sixth storage area 306a by a user of the external apparatus 31, whereas this stored content is inputted to the image file generating apparatus 10 via the communication network N and stored in the sixth storage area 306a of the image file 30a formed in the original image storage 124.

In the case of printing an image on a calendar, a processing information including the base color of a sheet of the calendar is inputted and stored in the sixth storage area 306a by a user of the external apparatus 32 to overwrite the processing information for the mug cup, whereas this stored content is inputted to the image file generating apparatus 10 via the communication network N and stored in the sixth storage area 306a of the image file 30a formed in the original image storage 124.

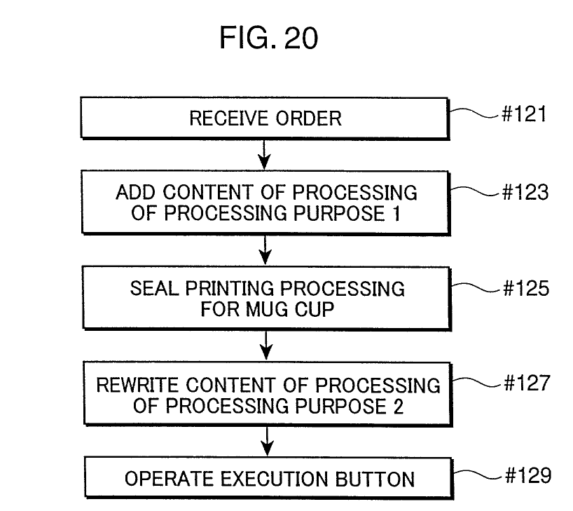

FIG. 20 is a flowchart showing a series of operations performed at the external apparatuses 31, 32 having received an order. First, an order is received by receiving the image file 30a from a customer via the communication network N (Step #121) and then the content of processing corresponding to the processing purpose 1 and to be applied to the mug cup at the external apparatus 31 is inputted and stored in the sixth storage area 306a of the received image file 30a by the user of the external apparatus 31 (Step #123).

Subsequently, the seal printer for the mug cup is started to perform a seal printing processing (Step #125). Then, the content of processing corresponding to the processing purpose 2 and to be applied to the calendar at the external apparatus 32 is inputted and stored in the sixth storage area 306a of the received image file 30a by the user of the external apparatus 32 (Step #127), and the calendar printer is started to perform a calendar printing processing (Step #129).

As described in the above embodiment, the processing purpose, e.g., “Printout”, “Print on Small-Size Mug Cup”, of the image data stored in the first storage areas 301, 301a of the image files 30, 30a are stored in the second storage areas 302, 302a according to the present invention. Thus, the application purposes of the image files 30, 30a can be made clear, thereby preventing an occurrence of such a confusion as to mistakenly use the image files 30, 30a for the purposes other than, for example, “Printout” and “Print on Small-Size Mug Cup”. Therefore, the aimed image processing result can be easily obtained within a short period of time.

The present invention is not limited to the foregoing embodiment, and may take various embodiments as described below.

(1) Although the image data obtained by the image pickup device such as an electronic camera is inputted by mounting a memory in the image data reader 14 in the foregoing embodiments, the present invention is not limited thereto. For example, a storage medium such as a floppy disk or a CD-ROM storing an image data obtained by the image pickup device such as an electronic camera may be mounted in an unillustrated reader provided in the main controller 12 and the image data may be read thereby to be stored in the original image storage 124. Alternatively, the image data can be inputted from an external apparatus using a communication network such as Internet or using a wireless equipment. In short, various image data input means may be provided.

(2) Although the processing purpose of the image data is selected form a plurality of processing purposes set beforehand in the foregoing embodiments, the present invention is not limited thereto. For example, the processing purpose may be inputted in characters by operating the keyboard 18. Although the image size is also selected from a plurality of sizes set beforehand, it may be inputted in characters by operating the keyboard 18.

(3) Although the image file 30a includes the fifth storage area 305a for storing the name of the external apparatus or URL and the sixth storage area 306a for storing the content of processing at the external apparatus in the foregoing embodiment, the present invention is not limited thereto. For example, the image file 30a may not include either the fifth storage area 305a or sixth storage area 306a or may not include both of them. In the case that the URL is stored in the fifth storage area 305a, the URL may be read from the image file and automatically connected with the URL.

In the foregoing embodiments, it should be noted that in the series of operations or routines executed to implement the embodiments of the invention, which are implemented as part of an operating system or a specific application, component, program, object, module or sequence of instructions, are referred to as “computer programs” or simply “programs”. Also, it should be appreciated that the embodiments of the invention can be distributed as a program product in a variety of signal bearing media, such as recordable type media (e.g., volatile memory devices, non-volatile memory devices, floppy and other removable disks, hard disk drives, optical disks), and transmission type media such as digital and analog communications such as the Internet.

As described above, the application or use of the image file can be made clear since the processing purpose of the image data stored in the first storage area is stored in the second storage area of the image file. As a result, an occurrence of such a confusion as to mistakenly use the image files for the purposes other than the intended one can be avoided. Therefore, the aimed image processing result can be easily obtained within a short period of time.

A program products for generating an image file including a first storage area for storing an image data, a second storage area for storing a processing purpose of the image data, and a third storage area for storing a content of processing to the image data, the program product comprising a program causing a computer to perform a step of receiving a processing purpose corresponding to the image data stored in the first storage area and inputted by a user, a step of storing the received processing purpose in the second storage area, a step of receiving a content of processing to the image data inputted by the user in conformity with the processing purpose of the image data, and a step of storing the received content of processing in the third storage area; and a signal bearing medium which bears the program.

With such program product, the processing purpose inputted by the user is stored in the second storage area and the content of processing inputted by the user in conformity with the processing purpose is stored in the third storage area. Since the processing purpose of the image data is stored in the second storage area in the image file thus generated, the application purpose of the image file can be made clear. As a result, an occurrence of such a confusion as to mistakenly use the image files for the purposes other than the intended one can be avoided. Therefore, the aimed image processing result can be easily obtained within a short period of time.

Preferably, before the processing purpose is inputted by the user, the computer may be caused to perform a step of displaying a plurality of processing purposes set beforehand on a display device according to a display instruction given by the user. The processing purpose is inputted by the user by selecting one from the plurality of purposes displayed on the display device.

With such a program, since a plurality of processing purposes set beforehand are displayed on the display device, the processing purpose can be inputted only by selecting one from the plurality of processing purposes. This simplifies an input operation and enables the aimed image processing result to be more easily obtained.

Also, a program product for generating an image file including a first storage area for storing an image data, a second storage area for storing a processing purpose of the image data, and a third storage area for storing a content of processing to the image data, the program product comprising a program causing a computer to perform a step of receiving a processing purpose newly inputted by a user, a step of overwriting the processing purpose stored in the second storage area with the newly received processing purpose, a step of receiving a content of processing newly inputted by the user in conformity with the new processing purpose, and a step of overwriting the content of processing stored in the third storage area with the newly received content of processing; and a signal bearing medium which bears the program.

With such program product, the processing purpose stored in the second storage area is overwritten with the one newly inputted by the user and the content of processing stored in the third storage area is overwritten with the one newly inputted by the user. Thus, a new image file can be generated with the image data stored in the first storage area left as it is.

Preferably, before the new processing purpose is inputted by the user, the computer may be caused to perform a step of reading the processing purpose from the second storage area in accordance with a read instruction given by the user, a step of displaying the read processing purpose on the display device, and a step of displaying a plurality of processing purposes set beforehand on the display device. The processing purpose is inputted by the user by selecting one from the plurality of processing purposes displayed on the display device.

With such program product, since a plurality of processing purposes set beforehand are displayed on the display device, the processing purpose can be inputted only by selecting one from the plurality of processing purposes. This simplifies an input operation and enables the aimed image processing result to be more easily obtained.

Preferably, a plurality of different contents of processing may be stored in the third storage area, and only part of the plurality of stored contents of processing is overwritten with the new content of processing inputted by the user with the remaining contents of processing left as they are.

With such program product, a new image file is generated by overwriting only part of the content of processing stored in the third storage area. Thus, a new image file can be easily generated.

Preferably, the remaining contents of processing include a trimming area of an image set by the user. With such program product, a new image file can be easily generated since the trimming area of the image which is relatively cumbersome to set is not overwritten.

Preferably, the remaining contents of processing include color conversion of the image set by the user. With such program product, a new image file can be easily generated since the color conversion of the image which is relatively cumbersome to set is not overwritten.

Preferably, the image data is the one obtained by picking up an image by means of an image pickup device.

With such program product, the image data obtained by the image pickup device is inputted and stored in the first storage area. It is desirable to store this image data in the first storage area so as not to substantially reduce its resolution. Such a storage enables a new image file to be easily generated only by overwriting the processing purpose or the like with the image data stored in the first storage area left as it is.

Further, a program product for generating an image file including a first storage area for storing an image data, a second storage area for storing a processing purpose of the image data, a third storage area for storing a content of processing to the image data in conformity with the processing purpose, and a fourth storage area for storing an order data of an article using the image data, the program product comprising a program causing a computer to perform a step of receiving a processing purpose corresponding to the image data stored in the first storage area and inputted from an external apparatus via a communication network when an article to be ordered is designated to the external apparatus via the communication network, a step of storing the received processing purpose in the second storage area, a step of receiving a content of processing to the image data inputted by the user in conformity with the processing purpose of the image data, a step of storing the received content of processing in the third storage area, a step of receiving an order data used to order an article using the image data and inputted by the user, and a step of storing the received order data in the fourth storage area; and a signal bearing medium which bears the program.

With such program product, the processing purpose inputted from the external apparatus via the communication network when the article to be ordered is designated to the external apparatus via the communication network is stored in the second storage area, the content of processing inputted by the user in conformity with the processing purpose is stored in the third storage area, and the order data used to order the article and inputted by the user is stored in the fourth storage area. The application purpose of the image file thus generated can be made clear since the processing purpose of the image data is stored in the second storage area. As a result, an occurrence of such a confusion as to mistakenly use the image files for the purposes other than the intended one can be avoided. Therefore, the aimed image processing result can be easily obtained within a short period of time.

Preferably, a plurality of different processing purposes may be stored in the second storage area. With such program product, the image file is generated with the plurality of processing purposes stored in the second storage area. Thus, the same image file is used for the plurality of processing purposes, thereby making the image file more efficient.

Preferably, the content of processing common to the plurality of processing purposes may be stored in the third storage area. With such program product, the image file is generated with the content of processing common to the plurality of processing purposes stored in the third storage area. Thus, the same content of processing is used for the plurality of processing purposes, thereby making the image file more efficient.

Preferably, the image file may be further provided with a fifth storage area for storing the name of the external apparatus receiving the order via the communication network, and the computer is caused to further perform a step of receiving the name of the external apparatus inputted by the user and a step of storing the received name of the external apparatus in the fifth storage area.

Such program product can prevent the order made via the communication network from being sent to a wrong ordering end since the image file is generated with the name of the external apparatus inputted by the user stored in the fifth storage area.

Preferably, the image file may be further provided with a sixth storage area for storing a content of processing at the external apparatus receiving the order via the communication network, and the computer is caused to further perform a step of receiving a content of the processing at the external apparatus inputted by a user of the external apparatus and a step of storing the received content of processing in the sixth storage area.

With such program product, the image processing is performed based on the content of processing stored in the sixth storage area since the image file is generated with the content of processing inputted by the user of the external apparatus stored in the sixth storage area.

A program product for applying an image processing to an image data using an image file in which the image data is stored in a first storage area, a processing purpose of the image data is stored in a second storage area, and a content of processing to the image data in conformity with the processing purpose is stored a third storage area, the program product comprising a program causing a computer to perform a step of reading the image data from the first storage area, a step of storing the read image data in a processing storage means, a step of reading the processing purpose from the second storage area, a step of reading the content of processing from the third storage area, and a step of applying an image processing to the image data stored in the processing storage means based on the read content of processing in conformity with the processing purpose; and a signal bearing medium which bears the program.

With such program product, the image data is read from the first storage area and stored in the processing storage part, and the image data stored in the processing storage part is processed. Since the image data stored in the first storage area is free from deterioration, a new image file can be easily generated only by overwriting the processing purpose or the like while using this image data as it is.

Preferably, in the image file, an order data of an article using the image data may be stored in a fourth storage area, and the name of an external apparatus receiving an order via a communication network may be stored in a fifth storage area.

With such program product, the image file is generated with the order data of the article using the image data stored in the fourth storage area and the name of external apparatus receiving the order via the communication network stored in the fifth storage area.

Preferably, the image file may be transmitted to the external apparatus receiving the order via the communication network and saved therein. With such a program, the image processing can be applied to the image data at the external apparatus.

Preferably, a content of processing at the external apparatus receiving the order via the communication network may be stored in a sixth storage area of the image file, and the image processing step is performing by applying the image processing to the image data stored in the first storage area based on the content of processing stored in the sixth storage area at the external apparatus.

Preferably, after the image processing is applied to the image data stored in the first storage area based on the content of processing stored in the sixth storage area, the computer may be caused to perform a step of applying a specified processing using the image data.

Moreover, an image file generating apparatus for generating an image file including a first storage area for storing an image data, a second storage area for storing a processing purpose of the image data, and a third storage area for storing a content of processing to the image data, comprising an input part for inputting the processing purpose of the image data stored in the first storage area and the content of processing to the image data corresponding to the processing purpose; and a storage controller for storing the processing purpose inputted by the input part in the second storage area and storing the content of processing inputted by the input part in the third storage area.

With such an apparatus, the processing purpose inputted by the user is stored in the second storage area and the content of processing inputted by the user in conformity with the processing purpose is stored in the third storage area. Since the processing purpose of the image data is stored in the second storage area in the image file thus generated, the application purpose of the image file can be made clear. As a result, an occurrence of such a confusion as to mistakenly use the image files for the purposes other than the intended one can be avoided. Therefore, the aimed image processing result can be easily obtained within a short period of time.

Furthermore, an image file generating apparatus for generating an image file including a first storage area for storing an image data, a second storage area for storing a processing purpose of the image data, a third storage area for storing a content of processing to the image data, and a fourth storage area for storing an order data of an article using the image data, comprising an input part for inputting the content of processing to the image data stored in the first storage area corresponding to the processing purpose of the image data and the order data used to order the article using the image data; and a storage controller for storing the processing purpose inputted from an external apparatus via a communication network in the second storage area when the article to be ordered is designated to the external apparatus via the communication network, storing the content of processing inputted by the input part in the third storage area, and storing the order data inputted by the input part in the fourth storage area.

With such an apparatus, the processing purpose inputted from the external apparatus via the communication network when the article to be ordered is designated to the external apparatus via the communication network is stored in the second storage area, the content of processing inputted by the user in conformity with the processing purpose is stored in the third storage area, and the order data used to order the article and inputted by the user is stored in the fourth storage area. The application purpose of the image file thus generated can be made clear since the processing purpose of the image data is stored in the second storage area. As a result, an occurrence of such a confusion as to mistakenly use the image files for the purposes other than the intended one can be avoided. Therefore, the aimed image processing result can be easily obtained within a short period of time.

Preferably, the image file may be provided with a fifth storage area for storing the name of the external apparatus receiving the order via the communication network; the input part inputs the name of the external apparatus; and the storage controller allows storing of the name of the external apparatus inputted by the input part in the fifth storage area.

With such an apparatus, the image file is generated with the order data of the article using the image data stored in the fourth storage area and the name of the external apparatus receiving the order via the communication network stored in the fifth storage area.

An image file generating method comprises the steps of receiving a first processing purpose for an image data, receiving a first processing content corresponding to the first processing purpose, and generating a fist image file including a first storage area for storing the image data, a second storage area for storing the first processing purpose, and a third storage area for storing the first processing content.

In this method, the processing purpose of the image data is stored in the second storage area. Thus, the application purpose of the image file can be made clear, which consequently avoids an occurrence of such a confusion as to mistakenly use the image files for the purposes other than the intended one.

A plurality of selective processing purposes may be preferably displayed on a display device for user's selection. Thus, a desirable processing purpose can be easily selected.

Further, it may be preferable to further provide the steps of receiving a second processing purpose for the first image file including the first storage area for storing the image data, the second storage area for storing the first processing purpose, and the third storage area for storing the first processing content, receiving a second processing content corresponding to the second processing purpose. In this case, the second storage area is stored with the second processing purpose and the third storage area is stored with the second processing content.

It may be also preferable to further provide the step of receiving an order data used to order an article using the image data. In this case, the received order data is stored in a fourth storage area of the image file.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A program product for generating an image file including a first storage area for storing an image data, a second storage area for storing a processing purpose of the image data, and a third storage area for storing a content of processing to the image data, the program product comprising:
a program causing a computer to perform a step of receiving a processing purpose corresponding to the image data stored in the first storage area and inputted by a user, a step of storing the received processing purpose in the second storage area, a step of receiving a content of processing to the image data inputted by the user in conformity with the processing purpose of the image data, and a step of storing the received content of processing in the third storage area; and
a signal bearing medium which bears the program.

2. The program product according to claim 1, wherein before the processing purpose is inputted by the user, the computer is caused to perform a step of displaying a plurality of processing purposes set beforehand on a display device according to a display instruction given by the user, and the processing purpose is inputted by the user by selecting one from the plurality of processing purposes displayed on the display device.

3. The program product according to claim 1, wherein the signal bearing medium includes at least one of a transmission-type medium and a recordable medium.

4. A program product for generating an image file including a first storage area for storing an image data, a second storage area for storing a processing purpose of the image data, and a third storage area for storing a content of processing to the image data, the program product comprising:
a program causing a computer to perform a step of receiving a processing purpose newly inputted by a user, a step of overwriting the processing purpose stored in the second storage area with the newly received processing purpose, a step of receiving a content of processing newly inputted by the user in conformity with the new processing purpose, and a step of overwriting the content of processing stored in the third storage area with the newly received content of processing; and
a signal bearing medium which bears the program.

5. The program product according to claim 4, wherein before the new processing purpose is inputted by the user, the computer is caused to perform a step of reading the processing purpose from the second storage area in accordance with a read instruction given by the user, a step of displaying the read processing purpose on a display device, and a step of displaying a plurality of processing purposes set beforehand on the display device, and the processing purpose is inputted by the user by selecting one from the plurality of processing purposes displayed on the display device.

6. The program product according to claim 4, wherein the third storage area is stored with a plurality of different processing contents, and only part of the plurality of stored processing contents is overwritten with the new processing content inputted by the user with the remaining processing contents left as they are.

7. The program product according to claim 6, wherein the remaining processing contents include a trimming area of an image set by the user.

8. The program product according to claim 6, wherein the remaining processing contents include rotation of the image set by the user.

9. The program product according to claim 6, wherein the remaining processing contents include color conversion of the image set by the user.

10. The program product according to claim 6, wherein the image data is data of an image picked up by an image pickup device.

11. The program product according to claim 4, wherein the signal bearing medium includes at least one of a transmission-type medium and a recordable medium.

12. A program product for generating an image file including a first storage area for storing an image data, a second storage area for storing a processing purpose of the image data, a third storage area for storing a content of processing to the image data in conformity with the processing purpose, and a fourth storage area for storing an order data of an article using the image data, the program product comprising:
a program causing a computer to perform a step of receiving a processing purpose corresponding to the image data stored in the first storage area and inputted from an external apparatus via a communication network when an article to be ordered is designated to the external apparatus via the communication network, a step of storing the received processing purpose in the second storage area, a step of receiving a content of processing to the image data inputted by the user in conformity with the processing purpose of the image data, a step of storing the received content of processing in the third storage area, a step of receiving an order data used to order an article using the image data and inputted by the user, and a step of storing the received order data in the fourth storage area; and
a signal bearing medium which bears the program.

13. The program product according to claim 12, wherein the second storage area is stored with a plurality of different processing purposes.

14. The program product according to claim 13, wherein the third storage area is stored with a processing content common to the plurality of processing purposes.

15. The program product according to claim 12, wherein the image file is further provided with a fifth storage area for storing the name of the external apparatus receiving the order via the communication network, and the computer is caused to further perform a step of receiving the name of the external apparatus inputted by the user and a step of storing the received name of the external apparatus in the fifth storage area.

16. The program product according to claim 12, wherein the image file is further provided with a sixth storage area for storing a content of processing at the external apparatus receiving the order via the communication network, and the computer is caused to further perform a step of receiving a content of the processing at the external apparatus inputted by a user of the external apparatus and a step of storing the received content of processing in the sixth storage area.

17. The program product according to claim 12, wherein the signal bearing medium includes at least one of a transmission-type medium and a recordable medium.

18. A program product for applying an image processing to an image data using an image file in which the image data is stored in a first storage area, a processing purpose of the image data is stored in a second storage area, and a content of processing to the image data in conformity with the processing purpose is stored in a third storage area, the program product comprising:
a program causing a computer to perform a step of reading the image data from the first storage area, a step of storing the read image data in a processing storage medium, a step of reading the processing purpose from the second storage area, a step of reading the content of processing from the third storage area, and a step of applying an image processing to the image data stored in the processing storage medium based on the read content of processing in conformity with the processing purpose; and
a signal bearing medium which bears the program.

19. The program product according to claim 18, wherein the image file further includes a fourth storage area for storing an order data of an article using the image data, and a fifth storage area for storing the name of an external apparatus receiving an order via a communication network.

20. The program product according to claim 19, wherein the image file is transmitted to the external apparatus receiving the order via the communication network and saved therein.

21. The program product according to claim 20, wherein the image file further includes a sixth storage area for storing a content of processing at the external apparatus receiving the order via the communication network, and the image processing step is performing by applying the image processing to the image data stored in the first storage area based on the content of processing stored in the sixth storage area at the external apparatus.

22. The program product according to claim 21, wherein after the image processing is applied to the image data stored in the first storage area based on the content of processing stored in the sixth storage area, the computer is caused to perform a step of applying a specified processing using the image data.

23. The program product according to claim 18, wherein the signal bearing medium includes at least one of a transmission-type medium and a recordable medium.

24. An image file generating apparatus for generating an image file including a first storage area for storing an image data, a second storage area for storing a processing purpose of the image data, and a third storage area for storing a content of processing to the image data, comprising:
an input part which inputs the processing purpose of the image data stored in the first storage area and the content of processing to the image data corresponding to the processing purpose; and
a storage controller which allows storing of the processing purpose inputted by the input part in the second storage area, and the content of processing inputted by the input part in the third storage area.

25. An image file generating apparatus for generating an image file including a first storage area for storing an image data, a second storage area for storing a processing purpose of the image data, a third storage area for storing a content of processing to the image data, and a fourth storage area for storing an order data of an article using the image data, comprising:
an input part which inputs the content of processing to the image data stored in the first storage area corresponding to the processing purpose of the image data and the order data used to order the article using the image data; and
a storage controller which allows storing of the processing purpose inputted from an external apparatus via a communication network in the second storage area when the article to be ordered is designated to the external apparatus via the communication network, and storing of the content of processing inputted by the input part in the third storage area, and storing of the order data inputted by the input means in the fourth storage area.

26. The image file generating apparatus according to claim 25, wherein the image file includes a fifth storage area for storing the name of the external apparatus receiving the order via the communication network, and the input part inputs the name of the external apparatus, and the storage controller allows storing of the name of the external apparatus inputted by the input means in the fifth storage area.

27. A method for generating an image file, comprising the steps of:
receiving a first processing purpose for an image data;
receiving a first processing content corresponding to the first processing purpose; and
generating a fist image file including a first storage area for storing the image data, a second storage area for storing the first processing purpose, and a third storage are a for storing the first processing content.

28. The method according to claim 26, wherein a plurality of selective processing purposes are displayed on a display device for user's selection.

29. The method according to claim 27, further comprising the steps of:
receiving a second processing purpose for the first image file including the first storage area for storing the image data, the second storage area for storing the first processing purpose, and the third storage area for storing the first processing content;
receiving a second processing content corresponding to the second processing purpose,
wherein the second storage area is stored with the second processing purpose and the third storage area is stored with the second processing content.

30. The method according to claim 27, further comprising the steps of:
receiving an order data used to order an article using the image data,
wherein the received order data is stored in a fourth storage area of the image file.
